(19) United States
(12) Patent Application Publication
(10) Pub. No.: US 2011/0217501 A1
(43) Pub. Date: Sep. 8, 2011

(54) DICING DIE-BONDING FILM

(76) Inventors: Yuichiro Shishido, Ibaraki-shi (JP); Takeshi Matsumura, Ibaraki-shi (JP); Shuhei Murata, Ibaraki-shi (JP)

(21) Appl. No.: 13/041,086

(22) Filed: Mar. 4, 2011

(30) Foreign Application Priority Data
Mar. 5, 2010 (JP) 2010-049595

(51) Int. Cl. B32B 33/00

(52) U.S. Cl. 428/41.8

(57) ABSTRACT

A dicing die-bonding film with excellent peeling property when a diced semiconductor chip and its die-bonding film are, without deteriorating a holding force during dicing a semiconductor wafer even if it is thin. A dicing die-bonding film, comprising a dicing film having at least a pressure-sensitive adhesive layer formed on a supporting base material, and a die-bonding film formed on the pressure-sensitive adhesive layer, wherein the thickness of the pressure-sensitive adhesive layer is 5 to 80 μm, and when the dicing film is peeled off from the die-bonding film after dicing from the side of the die-bonding film to a part of the pressure-sensitive adhesive layer, the maximum value of a peeling force in the vicinity of the cut surface is 0.7 N/10 mm or less under the conditions of a temperature of 23° C., a peeling angle of 180°, and a peeling point moving rate of 10 mm/min.

### BACKGROUND OF THE INVENTION

### Field of the Invention

The present invention relates to a dicing die-bonding film, for example, for use in manufacturing a semiconductor device and the like.

Conventionally, a silver paste has been used to fix a semiconductor chip to a lead frame or an electrode member in a process of manufacturing a semiconductor device. Such fixing process is performed by applying a paste onto a die pad of a lead frame, etc., mounting a semiconductor chip thereon, and then curing the paste-like adhesive layer.

A semiconductor wafer in which a circuit pattern is formed is diced into semiconductor chips (a dicing step) after the thickness thereof is adjusted as necessary by backside polishing (a back grinding step). These semiconductor chips are then fixed onto an adherend such as a lead frame with an adhesive (a die attaching step). Further, a wire bonding step has been performed. In the dicing step, the semiconductor wafer is generally washed with an appropriate liquid pressure in order to remove cutting debris.

A method of applying the adhesive separately onto a lead frame or a formed chip may be used in the treatment step. However, it is difficult to form a uniform adhesive layer, and a special apparatus and a long time are necessary to apply the paste-like adhesive in this method. For this reason, in Japanese Patent Application Laid-Open No. 60-57642, a dicing die-bonding film has been proposed which adheres and holds a semiconductor wafer in a dicing step and which provides an adhesive layer for fixing a chip that is necessary in the die attaching step.

This dicing die-bonding film is formed by providing a peelable adhesive layer on a support base. After a semiconductor chip is diced while being held by the adhesive layer, a formed chip is peeled together with the adhesive layer by stretching the support base, the chips are individually collected and fixed onto an adherend such as a lead frame through the adhesive layer.

Here, a strong adhesive strength such that a supporting base material and an adhesive layer are not peeled during dicing of a semiconductor wafer is required for a dicing die-bonding film, while a semiconductor chip is required to be easily peeled together with the adhesive layer from the supporting base material after dicing. However, it is difficult to adjust the adhesive strength of the adhesive layer if the dicing die-bonding film has the above mentioned constitution. For this reason, a dicing die-bonding film is disclosed which is constituted so that the balance between the adherability and the peeling properties becomes good by providing a pressure-sensitive adhesive layer between a supporting base material and an adhesive layer (see JP-A-2-248064).

However, as a semiconductor wafer becomes larger (10 mm×10 mm square or more) and thinner (about 15 to 100 μm in thickness), it is difficult for a conventional dicing die-bonding film to satisfy high tackiness that is necessary during dicing and a peeling property that is necessary during pickup at the same time, and thus it has become difficult to peel a semiconductor chip with a die-bonding film from a dicing tape. As a result, there is a problem of damages by pickup failure or chip deformation.

### SUMMARY OF THE INVENTION

The present invention has been made in light of the above mentioned problems, and an object thereof is to provide a dicing die-bonding film excellent in the peeling property when a semiconductor chip obtained by dicing is peeled off together with its die-bonding film, without deteriorating a holding force during dicing a semiconductor wafer even if it is thin.

The present inventors have studied so as to attain the object described above, and as a result, the present invention has been completed based on the finding that when dicing of the semiconductor wafer is conducted to a part of the pressure-sensitive adhesive layer, the part of the pressure-sensitive adhesive layer becomes a burr at the cut surface to adhere to the boundary between the pressure-sensitive adhesive layer and the die-bonding film, and then the adhered pressure-sensitive adhesive inhibits the peeling of the semiconductor chip with a die-bonding film from the pressure-sensitive adhesive layer, thereby making pickup difficult.

That is, the dicing die-bonding film of the present invention is a dicing die-bonding film, comprising a dicing film having at least a pressure-sensitive adhesive layer formed on a supporting base material, and a die-bonding film formed on the pressure-sensitive adhesive layer, wherein the thickness of the pressure-sensitive adhesive layer is 5 to 80 μm, and when the dicing film is peeled off from the die-bonding film after dicing from the side of the die-bonding film to a part of the pressure-sensitive adhesive layer, the maximum value of a peeling force in the vicinity of the cut surface is 0.7 N/10 mm or less under the conditions of a temperature of 23° C., a peeling angle of 180°, and a peeling point moving rate of 10 mm/min.

In the dicing die-bonding film of the above mentioned constitution, for example, the die-boding film to fix a semiconductor chip onto an adherend such as a substrate is used for subjecting the semiconductor wafer to dicing in a state where the dicing die-bonding film is attached to the semiconductor wafer before dicing. In a conventional dicing die-bonding film, when dicing is performed to a part of the pressure-sensitive adhesive layer, there is a case where the part of the pressure-sensitive adhesive layer becomes a burr at the cut surface to adhere to the boundary between the pressure-sensitive adhesive layer and the die-bonding film. However, with respect to the tackiness between the pressure-sensitive adhesive layer and the die-bonding film in the present invention, since the maximum value of a peeling force in the vicinity of the cut surface is 0.7 N/10 mm or less under the conditions as described above when the dicing film is peeled off from the die-bonding film, it can prevent a burr of the pressure-sensitive adhesive layer from generating at the cut surface, and prevent the pressure-sensitive adhesive from adhering to the boundary between the pressure-sensitive adhesive layer and the die-bonding film. As a result, improvement of a pickup property becomes possible.

In the above mentioned constitution, the storage elastic modulus of the pressure-sensitive adhesive layer at 23° C. is preferably 1×10⁷ Pa to 5×10⁸ Pa. When the storage elastic modulus is 1×10⁷ Pa or more, generation of chip fly during dicing can be prevented, and at the same time, generation of chip fly and a gap can be reduced during picking up the semiconductor chip. In addition, an increase in the wear amount of a dicing blade can be suppressed and a chipping rate can be decreased. On the other hand, when the storage elastic modulus is 5×10⁸ Pa or less, even if a part of the pressure-sensitive adhesive layer becomes a burr during dicing to adhere to the boundary between the pressure-sensitive adhesive layer and the die-bonding film at the cut surface, the burr is easily peeled off from the dicing line, making it possible to improve the pickup property.

Moreover, in the above mentioned constitution, the peeling force when the dicing film is peeled off from the die-bonding film is preferably within a range of 0.01 N/20 mm to 0.15 N/20 mm under the conditions of a temperature of 23° C., a peeling angle of 180°, and a peeling point moving rate of 300 mm/min before dicing. By allowing the peeling force to be within the range as described above when the dicing film before dicing is peeled off from the die-bonding film, the tackiness between the dicing film and the die-bonding film is prevented from becoming large excessively, making it possible to maintain the good pickup property.

In the above mentioned constitution, it is preferable that the pressure-sensitive adhesive layer is formed by a radiation-curing type pressure-sensitive adhesive, and a photopolymerizable compound in a range of more than 0 parts by weight to 50 parts by weight or less based on 100 parts by weight of a base polymer is added to the radiation-curing type pressure-sensitive adhesive.

In the above mentioned constitution, it is preferable that the pressure-sensitive adhesive layer is formed by a radiation-curing type pressure-sensitive adhesive, and a photopolymerizable compound in a range of 1 part by weight or more to 8 parts by weight or less based on 100 parts by weight of a base polymer is added to the radiation-curing type pressure-sensitive adhesive.

In the above mentioned constitution, it is preferable that the die-bonding film is formed by at least an epoxy resin, a phenol resin, an acrylic copolymer and a filler, and B/(A+B) is 0.1 or more when the total weight of the epoxy resin, the phenol resin, and the acrylic copolymer is defined as A parts by weight and the weight of the filler is defined as B parts by weight, and that the storage elastic modulus of the die-bonding film at 23° C. before thermal curing is 5 MPa or more. In the dicing step using a conventional dicing die-bonding film, a dicing blade is heated by friction at the time of cutting and cutting reaches the die-bonding film, whereby a part of the die-bonding film may become a burr at the cut surface to adhere to the boundary between the pressure-sensitive adhesive layer and the die-bonding film. However, it is possible to prevent a decrease in the pickup property due to a burr generated in the die-bonding film because adherence of the part of the die-bonding film as the burr is reduced by the above mentioned constitution.

According to the present invention, after dicing from the side of the die-bonding film to at least the part of the pressure-sensitive adhesive layer, the maximum value of a peeling force in the vicinity of the cut surface is made to be 0.7 N/10 mm or less under the conditions of a temperature of 23° C., a peeling angle of 180°, and a peeling point moving rate of 10 mm/min, when the dicing film is peeled off from the die-bonding film, and therefore even in the case where the part of the pressure-sensitive adhesive layer at the cut surface becomes a burr to adhere to the boundary between the pressure-sensitive adhesive layer and the die-bonding film, pickup failure due to the burr of the pressure-sensitive adhesive layer can be reduced.

### BRIEF DESCRIPTION OF THE DRAWINGS

FIG. 1 is a schematic cross-sectional view showing a dicing die-bonding film according to one embodiment of the present invention;

FIG. 2 is a schematic cross-sectional view showing a dicing die-bonding film according to another embodiment of the present invention;

FIGS. 3A and 3B are graphs each showing the relationship between a peeling distance and a peeling force when a dicing film is peeled off from a die-bonding film in the dicing die-bonding film;

FIG. 4 is a plane view showing a state where a semiconductor wafer is diced;

FIG. 5 is a schematic cross-sectional view showing a state where a semiconductor wafer is diced into a chip-shape; and

FIG. 6 is a schematic cross-sectional view showing an example wherein a semiconductor chip is mounted through a die-bonding film in the dicing die-bonding film.

### DETAILED DESCRIPTION OF THE PREFERRED EMBODIMENTS

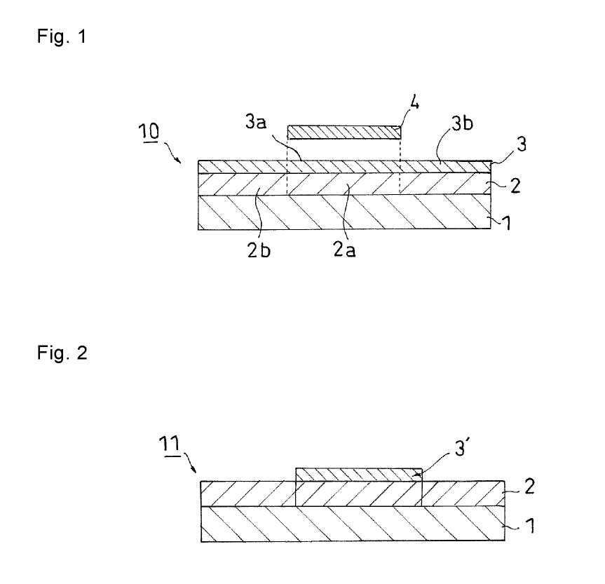

The embodiments of the present invention are described with reference to the drawings. FIG. 1 is a schematic cross-sectional view showing one example of the dicing die-bonding film according to the present embodiment. As shown in FIG. 1, a dicing die-bonding film 10 is constituted to include at least a pressure-sensitive adhesive layer 2 provided on a supporting base material 1 and a die-bonding film 3 provided on the pressure-sensitive adhesive layer 2. However, as shown in FIG. 2, the present invention may have a constitution wherein a die-bonding film 3′ is formed only on a semiconductor wafer pasting portion 2a.

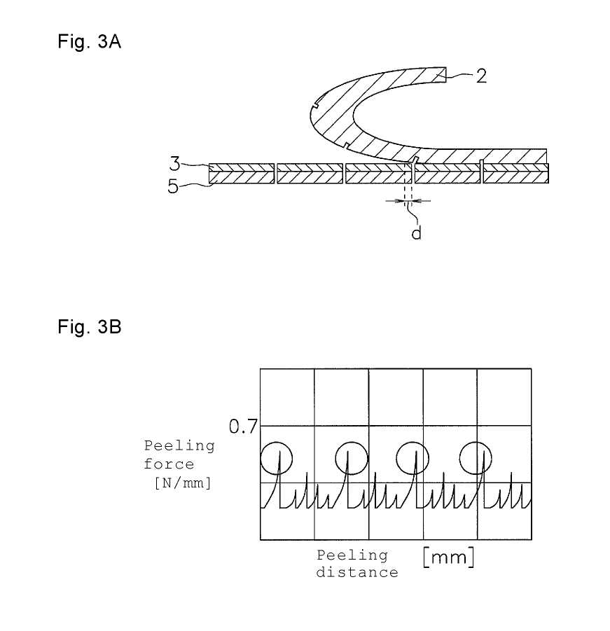

In the dicing die-bonding film 10 of the present embodiment, after dicing from the side of the die-bonding film 3 to at least a part of the pressure-sensitive adhesive layer 2, the maximum value of a peeling force in the vicinity of the cut surface is 0.7 N/10 mm or less, preferably 0.5 to 0.01 N/10 mm, and more preferably 0.2 to 0.01 N/10 mm, when the dicing film is peeled off from the die-bonding film 3. The vicinity of the cut surface refers to a region of d (mm) from the cut surface toward the inside of a semiconductor chip. In addition, the maximum peeling force value in the vicinity of the cut surface is a peak value when the dicing film is peeled off from the die-bonding film 3, as shown in FIGS. 3A and 3B for example. However, in the case where multiple peak values appear in the area of d (mm) from the cut surface toward the inside of a semiconductor chip 5, the maximum value of a peeling force means the maximum value of peak values. A concrete means to make the maximum peeling force value to be 0.7 N/10 mm or less includes a method of facilitating the peeling between the pressure-sensitive adhesive layer 2 and the die-bonding film 3 at the cut surface by allowing the storage elastic modulus of the pressure-sensitive adhesive layer 2 at 23° C. to be within a range of 1×10⁷ Pa to 5×10⁸ Pa (details of the storage elastic modulus of the pressure-sensitive adhesive layer 2 will be described later). Further, a method of suppressing generation of dicing debris from the die-bonding film 3 during dicing by adding a filler to the die-bonding film 3 and appropriately setting the amount of the filler is exemplified (details of the filler will be mentioned later). Moreover, the above mentioned d (mm) can be set to 1 mm though it depends on the size of the semiconductor chip 5. The above mentioned peeling force is a measurement value under the conditions of a peeling angle of 180°, and a peeling point moving rate of 10 mm/min. In addition, the range of the peeling force may be satisfied in at least a portion corresponding to the bonding pasting of the semiconductor wafer.

Further, in other than the vicinity of the cut surface, the peeling force under the conditions of a temperature of 23° C., a peeling angle of 180°, and a peeling point moving rate of 300 mm/min is preferably 0.01 to 0.15 N/20 mm and more preferably 0.02 to 0.1 N/20 mm, when the dicing film is peeled off from the die-bonding film 3. By allowing the peeling force to be within the range as described above when the dicing film is peeled off from the die-bonding film 3, tackiness between both films is prevented from becoming large excessively, and the pickup property can be further improved. A concrete means to make the peeling force to be within a range of 0.01 to 0.15 N/20 mm includes, for example, a method where the glass transition temperature of the die-bonding film 3 before thermal curing is set within a range of 0 to 60° C. Here, the die-bonding film 3 is cut out into a strip having a thickness of 200 μm, a width of 10 mm and a length of 40 mm with a utility knife, and the Tan δ (E″ (loss elastic modulus)/E′ (storage elastic modulus)) of the strip is measured under the conditions of a frequency of 1.0 Hz, a strain of 0.1%, and a temperature rising speed of 10° C./min at a temperature range of −50° C. to 300° C. using a viscoelasticity analyzer (type: RSA-III, manufactured by Rheometric Scientific, Inc.). The glass transition temperature of the die-bonding film 3 is a temperature at which Tan δ shows a local maximum value.

The supporting base material 1 is a base body for strength of the dicing die-bonding film 10, and preferably has ultraviolet-ray permeability. Examples thereof include polyolefin such as low-density polyethylene, straight chain polyethylene, intermediate-density polyethylene, high-density polyethylene, very low-density polyethylene, random copolymer polypropylene, block copolymer polypropylene, homopolypropylene, polybutene, and polymethylpentene; an ethylene-vinylacetate copolymer; an ionomer resin; an ethylene(meth)acrylic acid copolymer; an ethylene(meth)acrylic acid ester (random or alternating) copolymer; an ethylene-butene copolymer; an ethylene-hexene copolymer; polyurethane; polyester such as polyethyleneterephthalate and polyethylenenaphthalate; polycarbonate; polyetheretherketone; polyimide; polyetherimide; polyamide; whole aromatic polyamides; polyphenylsulfide; aramid (paper); glass; glass cloth; a fluorine resin; polyvinyl chloride; polyvinylidene chloride; a cellulose resin; a silicone resin; and a plastic film made of a mixture of these materials.

An example of a material of the supporting base material 1 is a polymer such as a cross-linked body of the resins described above. The plastic films may be used in a non-stretched state or may be used in a uniaxially or biaxially stretched state as necessary. With a resin sheet to which a heat shrinking property is imparted by a stretching treatment or the like, the adhering area of the pressure-sensitive adhesive layer 2 to the die-bonding films 3 and 3′ can be reduced by heat-shrinking the supporting base material 1 after dicing, and the semiconductor chips can be collected easily.

A known surface treatment such as a chemical or physical treatment such as a chromate treatment, ozone exposure, flame exposure, high voltage electric exposure, and an ionized ultraviolet treatment, and a coating treatment by an undercoating agent (for example, a tacky substance described later) can be performed on the surface of the base material 1 in order to improve adhesiveness, holding properties, etc. with the adjacent layer.

The same or different kinds of materials can be suitably selected and used for the supporting base material 1. A blend of two or more kinds of the materials may be used for the supporting base material 1, if necessary. In addition, as the supporting base material 1, it is possible to use a film in which an evaporated layer having a thickness of about 30 to 500 Å comprised of an electric conductive material such as a metal, an alloy and an oxide thereof is provided on the above mentioned plastic film in order to impart antistatic performance. Moreover, it is possible to use a laminate or the like obtained by bonding the above mentioned films each other or together with other films. Also, the supporting base material 1 may be a single layer or a multilayered laminated film with two or more layers of films using the above mentioned materials or the like. When the pressure-sensitive adhesive layer 2 is a radiation-curing type, it is preferred to use a supporting base material allowing radiations such as X-rays, ultraviolet rays and electron beams to pass therethrough at least partially.

The thickness of the supporting base material 1 is not particularly limited and can be appropriately determined, and it is generally from about 5 to 200 μm.

The pressure-sensitive adhesive layer 2 may be formed by a radiation-curing type pressure-sensitive adhesive. In this case, the pressure-sensitive adhesive layer 2 may not be cured before bonding with the die-bonding films 3, 3′, but preferably has been cured by radiation irradiation in advance. The cured portion does not have to be all regions of the pressure-sensitive adhesive layer 2, but at least a portion 2a of the pressure-sensitive adhesive layer 2 corresponding to a wafer pasting portion 3a may be cured (see FIG. 1). In the case where the pressure-sensitive adhesive layer 2 is cured by radiation irradiation before bonding with the die-bonding film 3, the tackiness can be suppressed from becoming excessively large at the interface between the pressure-sensitive adhesive layer 2 and the die-bonding film 3 because the pressure-sensitive adhesive layer 2 in a solid state is bonded to the die-bonding film 3. Accordingly, an anchor effect between the pressure-sensitive adhesive layer 2 and the die-bonding film 3 is decreased, making it possible to achieve improvement in the peeling property.

In addition, the radiation-curing type pressure-sensitive adhesive layer 2 may be cured in advance according to the shape of the die-bonding film 3′ shown in FIG. 2. Accordingly, the adhesion can be suppressed from becoming excessively large at the interface between the pressure-sensitive adhesive layer 2 and the die-bonding film 3. As a result, the easy peeling property of the die-bonding film 3′ from the pressure-sensitive adhesive layer 2 during pickup is provided. On the other hand, since other portion 2b of the pressure-sensitive adhesive layer 2 is uncured due to no radiation irradiation, the adhesive strength of the portion 2b is stronger than that of the portion 2a. Accordingly, when a dicing ring is attached onto the other portion 2b, the dicing ring can be securely attached and fixed.

As described above, the portion 2b that is formed with an uncured radiation-curing type pressure-sensitive adhesive adheres to the die-bonding film 3, and the holding force can be secured during dicing in the pressure-sensitive adhesive layer 2 of the dicing die-bonding film 10 shown in FIG. 1. As described above, the radiation curable pressure-sensitive adhesive can support the die-bonding film 3 for fixing a semiconductor chip onto an adherend such as a substrate with a good balance of adhering and peeling. In the pressure-sensitive adhesive layer 2 of the dicing die-bonding film 11 shown in FIG. 2, the portion 2b can fix a dicing ring. The dicing ring may be made of metal such as stainless steel, and resins.

The pressure-sensitive adhesive layer 2 has a storage elastic modulus at 23° C. of 1×10⁷ Pa to 5×10⁸ Pa, preferably 1×10⁷ Pa to 1×10⁸ Pa, and more preferably 1×10⁷ Pa to 5×10⁷ Pa. If the storage elastic modulus is 1×10⁷ Pa or more, generation of chip fly during dicing can be prevented, and generation of chip fly and a gap can be also reduced during picking up the semiconductor chip. In addition, an increase in the wear amount of a dicing blade 13 can be suppressed and a chipping rate can be decreased. On the other hand, if the storage elastic modulus is 5×10⁸ Pa or less, even if a part of the pressure-sensitive adhesive layer 2 becomes a burr during dicing to adhere to the boundary between the pressure-sensitive adhesive layer 2 and the die-bonding film 3 at the cut surface, the burr is easily peeled off from the dicing line, making it possible to improve the pickup property. As the dicing conditions for the numerical value range of the storage elastic modulus of the pressure-sensitive adhesive layer 2 to sufficiently exert an action/effect of the present invention, it is preferred that, for example, a dicing speed is in a range of 5 to 150 mm/sec and the number of rotations of the dicing blade 13 is in a range of 25000 to 50000 rpm. Moreover, even in the case where the pressure-sensitive adhesive layer 2 is a radiation-curing type pressure-sensitive adhesive layer mentioned later and is completely cured in advance by radiation irradiation, it is preferred that the storage elastic modulus satisfies 1×10⁷ Pa to 5×10⁸ Pa. Here, the complete curing refers to, for example, the case where curing by ultraviolet rays irradiation is performed with an accumulated light amount of 100 to 700 mJ/cm².

The thickness of the pressure-sensitive adhesive layer 2 is 5 to 80 μm, preferably 5 to 50 μm, and more preferably 5 to 30 μm. By allowing the thickness of the pressure sensitive layer 2 to be within the above mentioned range, prevention of chipping of the chip cut surface, compatibility of fixing and holding of the die bonding film 3, and the like can be achieved. In addition, by allowing the thickness of the pressure sensitive layer 2 to be within the above mentioned range, as well as by allowing the storage elastic modulus of the pressure-sensitive adhesive layer 2 at 23° C. to be in a range of 1×10⁷ to 5×10⁸ Pa, the cut depth during dicing is kept in the range of the pressure-sensitive adhesive layer 2 and thus the cut depth can be prevented from reaching the supporting base material 1.

The pressure-sensitive adhesive used for the formation of the pressure-sensitive adhesive layer 2 is not especially limited, and a radiation-curing type pressure-sensitive adhesive is preferable in the present invention. As the radiation-curing type pressure-sensitive adhesive, those having a radiation curable functional group such as a carbon-carbon double bond and having adherability can be used without particular limitation.

Example of the radiation-curing type pressure-sensitive adhesive includes an added type of a radiation-curing type pressure-sensitive adhesive in which a radiation-curable monomer component or a radiation-curable oligomer component is incorporated into a general pressure-sensitive adhesive such as the above mentioned acrylic pressure-sensitive adhesive, a rubber pressure-sensitive adhesive, a silicone pressure-sensitive adhesive, and a polyvinylether pressure-sensitive adhesive. The pressure-sensitive adhesive is preferably an acrylic pressure-sensitive adhesive having an acrylic polymer as a base polymer from the viewpoint of the clean washing properties of electric parts such as a semiconductor wafer and a glass, which should not be contaminated, with ultrapure water and an organic solvent such as alcohol.

Specific examples of the acrylic ester include an acryl polymer in which acrylate is used as a main monomer component. Examples of the acrylate include alkyl acrylate (for example, a straight chain or branched chain alkyl ester having 1 to 30 carbon atoms, and particularly 4 to 18 carbon atoms in the alkyl group such as methylester, ethylester, propylester, isopropylester, butylester, isobutylester, sec-butylester, t-butylester, pentylester, isopentylester, hexylester, heptylester, octylester, 2-ethylhexylester, isooctylester, nonylester, decylester, isodecylester, undecylester, dodecylester, tridecylester, tetradecylester, hexadecylester, octadecylester, and eicosylester) and cycloalkyl acrylate (for example, cyclopentylester, cyclohexylester, etc.). These monomers may be used alone or two or more types may be used in combination. All of the words including “(meth)” in connection with the present invention have an equivalent meaning.

The acrylic polymer may optionally contain a unit corresponding to a different monomer component copolymerizable with the above-mentioned alkyl ester of (meth)acrylic acid or cycloalkyl ester thereof in order to improve the cohesive force, heat resistance or some other property of the polymer. Examples of such a monomer component include carboxyl-containing monomers such as acrylic acid, methacrylic acid, carboxyethyl (meth)acrylate, carboxypentyl (meth)acrylate, itaconic acid, maleic acid, fumaric acid, and crotonic acid; acid anhydride monomers such as maleic anhydride, and itaconic anhydride; hydroxyl-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxylmethylcyclohexyl)methyl (meth)acrylate; sulfonic acid group containing monomers such as styrenesulfonic acid, allylsulfonic acid, 2-(meth)acrylamide-2-methylpropanesulfonic acid, (meth) acrylamidepropanesulfonic acid, sulfopropyl (meth)acrylate, and (meth) acryloyloxynaphthalenesulfonic acid; phosphoric acid group containing monomers such as 2-hydroxyethylacryloyl phosphate; acrylamide; and acrylonitrile. These copolymerizable monomer components may be used alone or in combination of two or more thereof. The amount of the copolymerizable monomer(s) to be used is preferably 40% or less by weight of all the monomer components.

For crosslinking, the acrylic polymer can also contain multifunctional monomers if necessary as the copolymerizable monomer component. Such multifunctional monomers include hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy (meth)acrylate, polyester (meth)acrylate, urethane (meth)acrylate etc. These multifunctional monomers can also be used as a mixture of one or more thereof. From the viewpoint of adhesiveness etc., the use amount of the multifunctional monomer is preferably 30 wt % or less based on the whole monomer components.

Preparation of the acrylic polymer can be performed by applying an appropriate manner such as a solution polymerization manner, an emulsion polymerization manner, a bulk polymerization manner, or a suspension polymerization manner to, for example, a mixture of one or more kinds of component monomers. Since the pressure-sensitive adhesive layer preferably has a composition in which the content of low molecular weight materials is suppressed from the viewpoints of prevention of wafer contamination and the like, the composition preferably includes an acrylic polymer having a weight average molecular weight of 300000 or more, particularly 400000 to 3000000 as a main component. Accordingly, the pressure-sensitive adhesive may be an appropriate crosslinked type with an internal crosslinking manner, an external crosslinking manner and the like.

Further, in order to control the crosslinking density of the pressure-sensitive adhesive layer 2, an appropriate manner can be adopted such as a manner of performing a crosslinking process using an appropriate external crosslinking agent including a polyfunctional isocyanate-based compound, a polyfunctional epoxy-based compound, a melamine-based compound, a metal salt-based compound, a metal chelate-based compound, an amino resin-based compound, or a peroxide; or a manner of performing a crosslinking process by mixing low molecular compounds having two or more carbon-carbon double bonds and irradiating energy rays. When the external crosslinking agent is used, the used amount is appropriately determined by a balance with the base polymer to be crosslinked and further by the use as the pressure-sensitive adhesive. Generally, it is about 5 parts by weight or less, and preferably 0.1 to 5 parts by weight to 100 parts by weight of the base polymer. Further, various additives such as a tackifier and an antioxidant may be used in the pressure-sensitive adhesive other than the above-described components as necessary.

Examples of the radiation-curing type monomer component to be compounded include such as urethane(meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta (meth)acrylate, dipentaerythritol hexa(meth)acrylate, and 1,4-butane dioldi(meth)acrylate. These monomer components can be used alone, or two or more kinds of monomer components can be used in combination.

Further, examples of the radiation-curable oligomer component include various oligomers such as urethane-based oligomers, polyether-based oligomers, polyester-based oligomers, polycarbonate-based oligomers and polybutadiene-based oligomers and those having a molecular weight in a range of about 100 to 30000 are preferred. The compounding amount of the radiation-curable monomer component or oligomer component can be appropriately determined as an amount of which the adhesive strength of the pressure-sensitive adhesive layer can be decreased depending on the kind of the above mentioned pressure-sensitive adhesive layer. Generally, the compounding amount is, for example, 5 to 500 parts by weight, and preferably about 70 to 150 parts by weight based on 100 parts by weight of the base polymer such as the acrylic polymer which constitutes the pressure-sensitive adhesive.

Further, besides the added type radiation-curing type pressure-sensitive adhesive described above, the radiation-curing type pressure-sensitive adhesive includes an internal radiation-curing type pressure-sensitive adhesive using an acryl polymer having a radical reactive carbon-carbon double bond in the polymer side chain, in the main chain, or at the end of the main chain as the base polymer. The internal radiation-curing type pressure-sensitive adhesives of an internally provided type are preferable because they do not have to contain the oligomer component, etc. that is a low molecular weight component, or most of them do not contain, they can form a pressure-sensitive adhesive layer having a stable layer structure without migrating the oligomer component, etc. in the pressure sensitive adhesive over time.

The above-mentioned base polymer, which has a carbon-carbon double bond, may be any polymer that has a carbon-carbon double bond and further has viscosity. As such a base polymer, a polymer having an acrylic polymer as a basic skeleton is preferable. Examples of the basic skeleton of the acrylic polymer include the acrylic polymers exemplified above.

The method for introducing a carbon-carbon double bond into any one of the above-mentioned acrylic polymers is not particularly limited, and may be selected from various methods. The introduction of the carbon-carbon double bond into a side chain of the polymer is easier in molecule design. The method is, for example, a method of copolymerizing a monomer having a functional group with an acrylic polymer, and then causing the resultant to condensation-react or addition-react with a compound having a functional group reactive with the above-mentioned functional group and a carbon-carbon double bond while keeping the radiation curability of the carbon-carbon double bond.

Examples of the combination of these functional groups include a carboxylic acid group and an epoxy group; a carboxylic acid group and an aziridine group; and a hydroxyl group and an isocyanate group. Of these combinations, the combination of a hydroxyl group and an isocyanate group is preferable from the viewpoint of the easiness of reaction tracing. If the above-mentioned acrylic polymer, which has a carbon-carbon double bond, can be manufactured by the combination of these functional groups, each of the functional groups may be present on any one of the acrylic polymer and the above-mentioned compound. It is preferable for the above-mentioned preferable combination that the acrylic polymer has the hydroxyl group and the above-mentioned compound has the isocyanate group. Examples of the isocyanate compound in this case, which has a carbon-carbon double bond, include methacryloyl isocyanate, 2-methacryloyloxyethyl isocyanate, and m-isopropenyl-α,α-dimethylbenzyl isocyanate. The used acrylic polymer may be an acrylic polymer copolymerized with anyone of the hydroxyl-containing monomers exemplified above, or an ether compound such as 2-hydroxyethyl vinyl ether, 4-hydroxybutyl vinyl ether or diethylene glycol monovinyl ether.

The intrinsic type radiation curable adhesive may be made only of the above-mentioned base polymer (in particular, the acrylic polymer), which has a carbon-carbon double bond. However, a photopolymerizable compound such as the above-mentioned radiation curable monomer component or oligomer component may be incorporated into the base polymer to such an extent that properties of the adhesive are not deteriorated. The compounding amount of the photopolymerizable compound is usually 30 parts or less by weight, preferably from 0 to 10 parts by weight for 100 parts by weight of the base polymer. However, in the case where it is an object to adjust the storage elastic modulus of the pressure-sensitive adhesive layer 2 to within a range of 1×10⁷ Pa to 5×10⁸ Pa, the compounding amount of the photopolymerizable compound is preferably in an amount of more than 0 parts by weight to 50 parts by weight or less, and more preferably more than 0 parts by weight to 30 parts by weight or less based on 100 parts by weight of the base polymer. If the compounding amount is within the numerical value range mentioned above, the storage elastic modulus of the pressure-sensitive adhesive layer 2 can be adjusted within the range mentioned above even though the pressure-sensitive adhesive layer 2 is in a state where it is completely cured in advance by radiation irradiation.

The radiation-curing type pressure-sensitive adhesive preferably contains a photopolymerization initiator in the case of curing it with an ultraviolet ray or the like Examples of the photopolymerization initiator include α-ketol compounds such as 4-(2-hydroxyethoxy)phenyl(2-hydroxy-2-propyl)ketone, α-hydroxy-α,α′-dimethylacetophenone, 2-methyl-2-hydroxypropiophenone, and 1-hydroxycyclohexyl phenyl ketone; acetophenone compounds such as methoxyacetophenone, 2,2-dimethoxy-2-phenylacetophenone, 2,2-diethoxyacetophenone, 1-hydroxycyclohexyl phenyl ketone and 2-methyl-1-[4-(methylthio)-phenyl]-2-morpholinopropane-1; benzoin ether compounds such as benzoin ethyl ether, benzoin isopropyl ether, and anisoin methyl ether; α-ketone compounds such as 2-methyl-2-hydroxypropiophenone; ketal compounds such as benzyl dimethyl ketal; aromatic sulfonyl chloride compounds such as 2-naphthalenesulfonyl chloride; optically active oxime compounds such as 1-phenone-1,1-propanedione-2-(o-ethoxycarbonyl)oxime; benzophenone compounds such as benzophenone, benzoylbenzoic acid, and 3,3′-dimethyl-4-methoxybenzophenone; thioxanthone compound such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; camphorquinone; halogenated ketones; acylphosphonoxides; and acylphosphonates. The amount of the photopolymerization initiator to be blended is, for example, from about 0.05 to 20 parts by weight for 100 parts by weight of the acrylic polymer or the like which constitutes the adhesive as a base polymer. However, in the case where it is an object to adjust the storage elastic modulus of the pressure-sensitive adhesive layer 2 to within a range of 1×10⁷ Pa to 5×10⁸ Pa, the compounding amount of the photopolymerization initiator is preferably in an amount of 1 part by weight or more to 8 parts by weight or less, and more preferably 1 part by weight or more to 5 parts by weight or less based on 100 parts by weight of the base polymer.

Further, examples of the radiation-curing type pressure-sensitive adhesive which is used in the formation of the pressure-sensitive adhesive layer 2 include such as a rubber pressure-sensitive adhesive or an acryl pressure-sensitive adhesive which contains an addition-polymerizable compound having two or more unsaturated bonds, a photopolymerizable compound such as alkoxysilane having an epoxy group, and a photopolymerization initiator such as a carbonyl compound, an organic sulfur compound, a peroxide, an amine, and an onium salt compound, which are disclosed in JP-A No. 60-196956. The addition polymerizable compound having two or more unsaturated bonds mentioned above includes, for example, polyalcohol-based esters or oligo esters of acrylic acid or methacrylic acid, epoxy-based compounds and urethane-based compounds.

The compounding amount of the photopolymerizable compounds and the photopolymerization initiator is, based on 100 parts by weight of the base polymer, generally 10 to 500 parts by weight and 0.05 to 20 parts by weight respectively. In addition to these compounding components, an epoxy functional crosslinking agent having one epoxy group or two or more epoxy groups in its molecule such as ethylene glycol glycidyl ether may be added to improve crosslinking efficiency of the pressure-sensitive adhesive.

The pressure-sensitive adhesive layer 2 using the radiation-curing type pressure-sensitive adhesive can contain a compound that is colored by radiation irradiation as necessary. By containing the compound that is colored by radiation irradiation in the pressure-sensitive adhesive layer 2, only a portion irradiated with radiation can be colored. That is, the pressure-sensitive adhesive layer 2a that corresponds to the wafer pasting portion 3a can be colored. Therefore, whether the pressure-sensitive adhesive layer 2 is irradiated with radiation or not can be visually determined right away, and the wafer pasting portion 3a can be recognized easily, and the pasting of the semiconductor wafer is easy. Further, when detecting a semiconductor element with a photosensor or the like, the detection accuracy improves, and no false operation occurs during pickup of the semiconductor element.

The compound that colors by radiation irradiation is colorless or has a pale color before the irradiation. However, it is colored by irradiation with radiation. A preferred specific example of the compound is a leuco dye. Common leuco dyes such as triphenylmethane, fluoran, phenothiazine, auramine, and spiropyran dyes can be preferably used. Specific examples thereof include 3-[N-(p-tolylamino)]-7-anilinofluoran, 3-[N-(p-tolyl)-N-methylamino]-7-anilinofluoran, 3-[N-(p-tolyl)-N-ethylamino]-7-anilinofluoran, 3-diethylamino-6-methyl-7-anilinofluoran, crystal violet lactone, 4,4′,4″-trisdimethylaminotriphenylmethanol, and 4,4′,4″-trisdimethylaminotriphenylmethane.

Examples of a developer that is preferably used with these leuco dyes include a prepolymer of a conventionally known phenolformalin resin, an aromatic carboxylic acid derivative, and an electron acceptor such as activated white earth, and various color developers can be used in combination for changing the color tone.

The compound that colors by irradiation with radiation may be included in the radiation-curing type pressure-sensitive adhesive after being dissolved in an organic solvent or the like, or may be included in the pressure-sensitive adhesive layer 2 in the form of a fine powder. The ratio of use of this compound is preferably 0.01 to 10% by weight, and more preferably 0.5 to 5% by weight in the pressure-sensitive adhesive layer 2. When the ratio of the compound exceeds 10% by weight, the curing of the pressure-sensitive adhesive layer 2a becomes insufficient because the radiation onto the pressure-sensitive adhesive layer 2 is absorbed too much by this compound, and the adhesive strength may not reduce sufficiently. On the other hand, when the compound is used in a ratio of less than 0.01% by weight, a pressure-sensitive adhesive sheet may not be colored enough at the time of radiation irradiation, and malfunction may occur easily at the time of picking up a semiconductor element.

When the pressure-sensitive adhesive layer 2 is formed by the radiation-curing type pressure-sensitive adhesive, there can be exemplified a method of forming the radiation-curing type pressure-sensitive adhesive layer 2 on the supporting base material 1 and then curing the layer by irradiating the portion that corresponds to the wafer pasting portion 3a partially with radiation. The partial irradiation with radiation can be performed through a photo mask that has a pattern corresponding to the portion 3b or the like other than the wafer pasting portion 3a. Another example is a method of curing the layer by irradiation in spots. The formation of the radiation-curing type pressure-sensitive adhesive layer 2 can be performed by transferring a layer provided on a separator onto the supporting base material 1. The partial radiation curing can also be performed on the radiation-curing type pressure-sensitive adhesive layer 2 that is provided on the separator.

Further, when forming the pressure-sensitive adhesive layer 2 with a radiation-curing type pressure-sensitive adhesive, the pressure-sensitive adhesive layer 2a having a reduced adhesive strength can be formed by using at least one surface of the supporting base material 1 where the whole or part of the portion other than the portion corresponding to the wafer pasting portion 3a is protected from light, forming the radiation-curing type pressure-sensitive adhesive layer 2 on this surface, and curing the portion corresponding to the wafer pasting portion 3a by irradiation with radiation. As a light-shielding material, a material that is capable of serving as a photo mask on a supporting film can be manufactured by printing, vapor deposition, or the like. According to such a manufacturing method, the dicing die-bonding film of the present invention can be efficiently manufactured.

When curing is inhibited due to oxygen during irradiation with radiation, it is desirable to shield oxygen (air) against the surface of the radiation-curing type pressure-sensitive adhesive layer 2. Examples of the method for shielding oxygen include a method of covering the surface of the pressure-sensitive adhesive layer 2 with a separator and a method of performing irradiation with an ultraviolet ray or the like in a nitrogen gas atmosphere.

The pressure-sensitive adhesive layer 2 may be constituted to have the following relationship regarding the peeling property with the die-bonding film 3. That is, there is a relationship that the peeling property in the interface corresponding to the wafer pasting portion 3a of the die-bonding film 3 (hereinafter may be also referred to as die-bonding film 3a) is larger than that corresponding to the other portion 3b (hereinafter may be also referred to as die-bonding film 3b). In order to satisfy this relationship, the pressure-sensitive adhesive layer 2 is designed to satisfy, for example, the following relationship: the adhesive strength of the portion 2a (hereinafter may be also referred to as pressure-sensitive adhesive layer 2a) corresponding to the wafer pasting portion 3a (described later) < the adhesive strength of the portion 2b (hereinafter may be also referred to as pressure-sensitive adhesive layer 2b) corresponding to apart or whole of the other portion.

The pressure-sensitive adhesive which constitutes the pressure-sensitive adhesive layer 2 is not particularly limited, but the radiation-curing type pressure-sensitive adhesive described above is preferred in the present embodiment. This is because a difference can be easily given to the adhesive strength between the pressure-sensitive adhesive layer 2a and the pressure-sensitive adhesive layer 2b. The radiation-curing type pressure-sensitive adhesive can easily decrease the adhesive strength by increasing the degree of crosslinking through irradiation of radiation such as ultraviolet rays. Therefore, a region where the adhesive strength is remarkably decreased can be easily manufactured by irradiating radiation and curing the pressure-sensitive adhesive layer 2a corresponding to the wafer pasting portion 3a. Since the wafer pasting portion 3a of the die-bonding film 3 is located in the pressure-sensitive adhesive layer 2a which is cured and in which the adhesive strength is decreased, an interface between the pressure-sensitive adhesive layer 2a and the wafer pasting portion 3a has the property of being easily peeled at the time of pickup.

On the other hand, since the pressure-sensitive adhesive layer 2b in which radiation is not irradiated is formed by an uncured radiation-curing type pressure-sensitive adhesive, it has a sufficient adhesive strength. For this reason, the pressure-sensitive adhesive layer 2b is certainly adhered to the die bonding film 3, and as a result, the pressure-sensitive adhesive layer 2 as a whole can secure a holding force to sufficiently fix the die bonding film 3 during dicing. The pressure-sensitive adhesive layer 2 which is thus constituted by the radiation-curing type pressure-sensitive adhesive can support the die-bonding adhesive layer 3 for fixing a semiconductor chip and the like on a substrate or a semiconductor chip with the good balance of adhesion and peeling off.

Further, in the dicing die-bonding film 10 shown in FIG. 1, the peeling force when the pressure-sensitive adhesive layer 2b is peeled off from the die-bonding film 3 is preferably 0.02 to 0.14 N/20 mm, and more preferably 0.04 to 0.08 N/20 mm, under the conditions of a temperature of 23° C., a peeling angle of 180°, and a peeling point moving rate of 300 mm/min. By allowing the peeling force to be within such a range, generation of chip fly can be suppressed during dicing and a holding force sufficient for wafer processing can be exerted.

The storage elastic modulus (23° C.) of the die-bonding film 3 before thermal curing is preferably 5 MPa or more, more preferably 10 to 10000 MPa, and especially preferably 100 to 5000 MPa. If the storage elastic modulus before thermal curing is 5 MPa or more, adhesion of a burr derived from a part of the die-bonding film during dicing to the boundary between the pressure-sensitive adhesive layer and the die-bonding film at the cut surface can be reduced, and a decrease in the pickup property due to the burr of the die-bonding film can be prevented. Here, by allowing the storage elastic modulus to be 10000 MPa or less, the die-bonding film 3 can have good wettability and tackiness to a semiconductor wafer which is to be mounted on the die-bonding film 3. Here, measurement of the storage elastic modulus can be conducted using a viscoelasticity spectrometer (RSA-II, manufactured by Rheometric Scientific, Inc.). That is, a sample size is made to be 30 mm in length (measurement length), 10 mm in width, and 0.5 mm in thickness and a measurement sample is set in a jig for film tensile measurement. Then a tensile storage elastic modulus and a loss elastic modulus at a temperature range of −50 to 200° C. are measured under the measurement conditions of a frequency of 1 Hz, and a temperature rising rate of 10° C./min, and a storage elastic modulus E′ (25° C.) can be read as the storage elastic modulus.

Examples of the die-bonding film 3 include, for example, those formed by a thermoplastic resin and a thermosetting resin, and specifically include those formed by an epoxy resin, a phenol resin, and an acrylic copolymer.

The epoxy resin may be any epoxy resin that is ordinarily used as an adhesive composition. Examples thereof include bifunctional or polyfunctional epoxy resins such as bisphenol A type, bisphenol F type, bisphenol S type, brominated bisphenol A type, hydrogenated bisphenol A type, bisphenol AF type, biphenyl type, naphthalene type, fluorene type, phenol Novolak type, orthocresol Novolak type, tris-hydroxyphenylmethane type, and tetraphenylolethane type epoxy resins; hydantoin type epoxy resins; tris-glycicylisocyanurate type epoxy resins; and glycidylamine type epoxy resins. These may be used alone or in combination of two or more thereof. Among these epoxy resins, an epoxy resin having an aromatic ring such as a benzene ring, a biphenyl ring or a naphthalene ring is especially preferred in the present invention. Specifically, Examples of such an epoxy resin include, for example, a novolac type epoxy resin, a xylylene skeleton-containing phenol novolac type epoxy resin, a biphenyl skeleton-containing novolac type epoxy resin, a bisphenol A type epoxy resin, a bisphenol F type epoxy resin, a tetramethylbiphenol type epoxy resin and a triphenylmethane type epoxy resin. The reason why these epoxy resins are preferable is that they have high reactivity with a phenol resin as a curing agent, and are excellent in heat resistance and the like. Here, the epoxy resin has fewer ionic impurities that corrode a semiconductor element.

The weight average molecular weight of the epoxy resin is preferably within a range of 300 to 1500, and more preferably within a range of 350 to 1000. If the weight average molecular weight is less than 300, the mechanical strength, heat resistance, and moisture resistance of the die-bonding film 3 after thermal curing may be decreased. On the other hand, if the weight average molecular weight is more than 1500, the die-bonding film after thermal curing may become rigid and fragile. Further, the weight average molecular weight in the present invention means a value in terms of polystyrene as measured by a gel permeation chromatography method (GPC) using a calibration curve with standard polystyrene.

The phenol resin is a resin acting as a curing agent for the epoxy resin. Examples thereof include Novolak type phenol resins such as phenol Novolak resin, phenol biphenyl resin, phenol aralkyl resin, cresol Novolak resin, tert-butylphenol Novolak resin and nonylphenol Novolak resin; resol type phenol resins; and polyoxystyrenes such as poly(p-oxystyrene). These may be used alone or in combination of two or more thereof. Among these phenol resins, phenol Novolak resin and phenol aralkyl resin are particularly preferable, since the connection reliability of the semiconductor device can be improved.

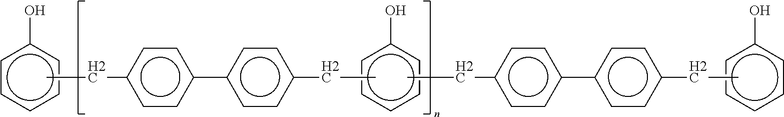

(n is a natural number of 0 to 10)

The above mentioned n is preferably a natural number ranging from 0 to 10, more preferably a natural number ranging from 0 to 5. With the above mentioned numerical range, it is possible to secure fluidity of the die-bonding film 3.

The weight average molecular weight of the above mentioned phenol resin is preferably within a range of 300 to 1500 and more preferably within a range of 350 to 1000. If the weight average molecular weight is less than 300, the thermal curing of the epoxy resin becomes insufficient and thus enough toughness may not be obtained. On the other hand, if the weight average molecular weight is more than 1500, the phenol resin has high viscosity and the workability at the time of manufacturing a die-bonding film may be decreased.

About the blend ratio between the epoxy resin and the phenol resin, for example, the phenol resin is blended with the epoxy resin in such a manner that the hydroxyl groups in the phenol resin is preferably from 0.5 to 2.0 equivalents, more preferably from 0.8 to 1.2 equivalents per equivalent of the epoxy groups in the epoxy resin component. If the blend ratio between the two is out of the range, curing reaction therebetween does not advance sufficiently so that properties of the cured epoxy resin easily deteriorate.

The acrylic copolymer is not particularly limited, but a carboxyl group-containing acrylic copolymer and an epoxy group-containing acrylic copolymer are preferred in the present invention. Examples of a functional group monomer used for the carboxyl group-containing acrylic copolymer include acrylic acid or methacrylic acid. The content of the acrylic acid or methacrylic acid is adjusted to within an acid value of 1 to 4. A mixture of an alkyl acrylate such as methyl acrylate having an alkyl group with 1 to 8 carbon atoms, an alkyl methacrylate such as methyl methacrylate having an alkyl group with 1 to 8 carbon atoms, styrene, and acrylonitrile can be used for the remaining portion. Among these, ethyl (meth)acrylate and/or butyl (meth)acrylate are especially preferred. The mixing ratio is preferably adjusted taking into consideration the glass transition point (Tg) of the above mentioned acrylic copolymer. In addition, a polymerization method is not particularly limited, and conventionally known methods such as a solution polymerization method, a bulk polymerization method, a suspension polymerization method, or an emulsion polymerization method can be employed.

Further, other polymerizable monomer components copolymerizable with the monomer components mentioned above are not particularly limited, and examples thereof include acrylonitrile and the like. The amount for use of these copolymerizable monomer components is preferably within a range of 1 to 20% by weight based on the entire monomer components. By containing the other monomer components within the above mentioned numerical value range, cohesive strength and tackiness can be improved.

The polymerization method of the acrylic copolymer is not particularly limited, and conventionally known methods such as a solution polymerization method, a bulk polymerization method, a suspension polymerization method, or an emulsion polymerization method can be employed.

The glass transition point (Tg) of the acrylic copolymer is preferably −30 to 30° C. and more preferably −20 to 15° C. By allowing the glass transition point to be −30° C. or more, heat resistance can be secured. On the other hand, by allowing the glass transition point to be 30° C. or less, a preventive effect on chip fly after dicing in a wafer having a rough surface is improved.

The weight average molecular weight of the acrylic copolymer is preferably 100000 to 1000000 and more preferably 350000 to 900000. By allowing the weight average molecular weight to be 100000 or more, tackiness to the surface of an adherend at a high temperature is excellent and heat resistance can be improved. On the other hand, if the weight average molecular weight is made to be 1000000 or less, the acrylic copolymer can be easily dissolved in an organic solvent.

In addition, a filler may be added to the die-bonding film 3. Examples of the filler include an inorganic filler or an organic filler. From the viewpoints of improvements of handleability and thermal conductivity, adjustment of melt viscosity, and imparting of thixotropic property, an inorganic filler is preferred.

Examples of the inorganic filler include, but are not especially limited to, silica, aluminum hydroxide, calcium hydroxide, magnesium hydroxide, antimony trioxide, calcium carbonate, magnesium carbonate, calcium silicate, magnesium silicate, calcium oxide, magnesium oxide, aluminum oxide, aluminum nitride, aluminum borate, boron nitride, crystalline silica, and amorphous silica. These inorganic fillers can be used alone or in combination of two or more fillers. From the viewpoint of improvement of thermal conductivity, aluminum oxide, aluminum nitride, boron nitride, crystalline silica, amorphous silica and the like are preferred. In addition, silica is preferred form the viewpoint of balance of the tackiness of the die-bonding film 3. Moreover, examples of the organic filler include polyimides, polyamideimides, polyether ether ketones, polyetherimides, polyesterimides, nylon, silicone and the like. These organic fillers can be used alone or in combination of two or more fillers.

The average particle size of the filler is preferably in a range of 0.005 to 10 μm, and more preferably in a range of 0.05 to 1 μm. When the average particle size of the filler is 0.005 μm or more, wettability to an adherend becomes favorable and a decrease in tackiness can be suppressed. On the other hand, by allowing the average particle size to be within a range of 10 μm or less, a reinforcing effect to the die-bonding film 3 by addition of a filler is enhanced and heat resistance is improved. Moreover, fillers having a different average particle size one another may be combined and used. In addition, the average particle size of the filler is a value that is obtained, for example, with an optical particle size distribution meter (manufactured by HORIBA, Ltd., name of device: LA-910).

The shape of the filler is not particularly limited and the filler can be used in, for example, a spherical or ellipsoidal form.

In addition, when the total weight of an epoxy resin, a phenol resin, and an acrylic copolymer is defined as A parts by weight and the weight of a filler is defined as B parts by weight, the ratio B/(A+B) is preferably 0.1 or more, more preferably 0.2 to 0.8, and especially preferably 0.2 to 0.6. By allowing the compounding amount of the filler to be 0.1 or more based on the total weight of an epoxy resin, a phenol resin, and an acrylic copolymer, it becomes possible to adjust the storage elastic modulus at 23° C. of the die-bonding film 3 to 5 MPa or more.

Moreover, other additives can be appropriately blended to the die-bonding films 3 and 3′ depending on necessity. Examples of the additives include flame retardants, silane coupling agents, and ion trapping agents.

Examples of the flame retardants include antimony trioxide, antimony pentoxide, and brominated epoxy resins. These can be used alone or two types or more of them can be used together.

Examples of the silane coupling agents include β-(3,4-epoxycyclohexyl)ethyltrimethoxysilane, γ-glycidoxypropyltrimethoxysilane, and γ-glycidoxypropylmethyldiethoxysilane. These compounds can be used alone or two types or more of them can be used together.

Examples of the ion trapping agents include hydrotalcite, bismuth hydroxide. These can be used alone or two types or more of them can be used together.

A thermosetting accelerating catalyst of the epoxy resin and the phenol resin are not particularly limited, and examples thereof preferably include salts comprised of any of a triphenylphosphine skeleton, an amine skeleton, a triphenylborane skeleton and a trihalogenborane skeleton.

From the viewpoint of reducing the maximum value a peeling force in the vicinity of the cut surface when the dicing film is peeled off from the die-bonding film 3, it is preferred that the die-bonding film 3 is formed with a filler content of 30% by weight or more. In the case where the die-bonding film 3 is formed with a filler content of 30% by weight or more, it is possible to reduce adherence of a part of the die-bonding film 3 which becomes a burr at the cut surface during dicing to the boundary between the pressure-sensitive adhesive layer 2 and the die-bonding film 3.

The thickness (total thickness in the case of a laminate) of the die-bonding film 3 is not particularly limited, and it is, for example, about 5 to 100 μm and preferably about 5 to 50 μm.

Here, the die-bonding films 3, 3′ can have a constitution including, for example, only a single layer of an adhesive layer. In addition, the die-bonding films 3, 3′ may have a multi-layered structure of two or more layers by appropriately combining a thermoplastic resin having a different glass transition temperature and a thermosetting resin having a different heat curing temperature. Here, because water for cutting is used in the dicing step of a semiconductor wafer, there is a case where the die-bonding film absorbs moisture and has the moisture content in a normal condition or more. When the die-bonding film is adhered to a substrate or the like with such a high moisture content, water vapor is accumulated on an adhering interface at the stage of after-curing, and thus there is a case where floating is generated. Therefore, by allowing the die-bonding film to have a constitution of sandwiching a core material having a high moisture permeability with adhesive layers, water vapor diffuses through the film at the stage of after-curing, and such problems can be avoided. From such a viewpoint, the die-bonding film may have a multi-layered structure in which an adhesive layer is formed on one face or both faces of a core material.

Examples of the core material include films (such as polyimide film, polyester film, polyethylene terephthalate film, polyethylene naphthalate film, and polycarbonate film); resin substrates which are reinforced with glass fiber or plastic nonwoven finer; mirror silicon wafer; silicon substrates; and glass substrates.

The die-bonding films 3, 3′ are preferably protected by a separator (not shown). The separator has a function as a protecting material that protects the die-bonding films until they are practically used. Further, the separator can be used as a supporting base material when transferring the die-bonding films 3, 3′ to the dicing film. The separator is peeled when pasting a semiconductor wafer onto the die-bonding films 3, 3′. Polyethylenetelephthalate (PET), polyethylene, polypropylene, a plastic film, a paper, etc. whose surface is coated with a peeling agent such as a fluorine based peeling agent and a long chain alkylacrylate based peeling agent can be also used as the separator.

### (Method for Manufacturing Semiconductor Device)

A method for manufacturing a semiconductor device using the dicing die-bonding film 10 according to the present embodiment will be described below.

First, a semiconductor wafer 4 is press-bonded onto the wafer pasting portion 3a of the die-bonding film 3 in the dicing die-bonding film 10 and is adhered and holded to be fixed (attaching step). The present step is performed while pressing with a pressing means such as a press-bonding roll. The attaching temperature during mounting is not particularly limited, but it is preferably, for example, within a range of 20 to 80° C.

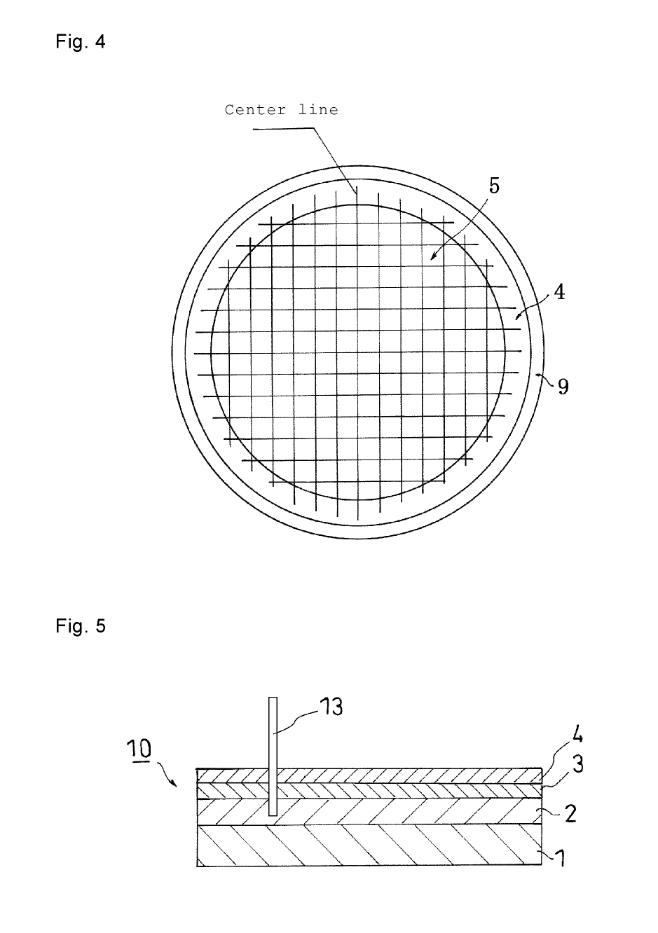

Next, dicing of the semiconductor wafer 4 is performed as shown in FIG. 4. At this time, a dicing ring 9 is attached onto the portion 3b other than the wafer pasting portion 3a in the die-bonding film 3. With this dicing, the semiconductor wafer 4 is cut into a prescribed size to obtain individual pieces, thereby manufacturing a semiconductor chip 5. The dicing is conducted, for example, from the circuit face side of the semiconductor wafer 4. At this time, cutting-in of the dicing blade 13 to the dicing die-bonding film 10 is conducted to an extent that the die-bonding film 3 is completely cut and at least a part of the pressure-sensitive adhesive layer 2 is cut (see FIG. 5). However, it is not preferred to perform the cutting-in to such an extent that the pressure-sensitive adhesive layer 2 is completely cut and the cutting-in reaches the supporting base material 1 because filamentous debris may be generated.

The dicing apparatus used in the dicing step is not particularly limited, and a conventionally known apparatus can be used. Further, because the semiconductor wafer 4 is adhered and fixed by the dicing die-bonding film 10, chip crack and chip fly can be suppressed, and at the same time the damage of the semiconductor wafer can be also suppressed.

Pickup of the semiconductor chip 5 is performed in order to peel a semiconductor chip that is adhered and fixed to the dicing die-bonding film 10. The method of picking up is not particularly limited. Examples include a method of pushing up the individual semiconductor chip 5 from the dicing die-bonding 10 side with a needle and picking up the pushed semiconductor chip 5 with a picking-up apparatus.

Here, when the pressure-sensitive adhesive layer 2 is a radiation-curing type and is uncured, pickup is preferably performed after radiation irradiation to the pressure-sensitive adhesive layer 2. In the case where the pressure-sensitive adhesive layer 2 is a radiation-curing type and is completely cured in advance, pickup is performed without radiation irradiation. In any case, since the adhesive strength of the pressure-sensitive adhesive layer 2 to the die-bonding film 3 is decreased, peeling off of the semiconductor chip 5 can be easily performed. As a result, it is possible to conduct pickup without damaging the semiconductor chip 5. The conditions during radiation irradiation such as irradiation intensity and irradiation time are not especially limited, and may be appropriately set as necessary.

Next, the semiconductor chip 5 formed by dicing is die-bonded to an adherend 6 through the die-bonding film 3a interposed therebetween. Die-bonding is carried out by press-bonding. The conditions of die-bonding are not especially limited, and may be appropriately set as necessary. Specifically, die-bonding can be performed within a die-bonding temperature of 80 to 160° C., a bonding pressure of 5 N to 15 N, and a bonding time of 1 to 10 seconds.

Examples of the adherend 6 include a lead frame, a TAB film, a substrate, and a semiconductor chip separately manufactured. The adherend 6 may be, for example, a deformable adherend that can be easily deformed or may be a non-deformable adherend that is difficult to be deformed such as a semiconductor wafer. A conventionally known substrate can be used as the substrate. Further, a metal lead frame such as a Cu lead frame and a 42 Alloy lead frame and an organic substrate composed of glass epoxy, BT (bismaleimide-triazine), and polyimide can be used as the lead frame. However, the present invention is not limited to this, and includes a circuit substrate that can be used by mounting a semiconductor element and electrically connecting with the semiconductor element.

Then, the die-bonding film 3a is thermally cured by performing a heat treatment, and the semiconductor chip 5 is adhered to the adherend 6. The condition of the heat treatment is a temperature of 80 to 180° C. and a heating time of 0.1 to 24 hours, preferably 0.1 to 4 hours, and more preferably 0.1 to 1 hour.

Next, a wire bonding step of electrically connecting the tip of a terminal part (inner lead) of the adherend 6 with an electrode pad (not shown) on the semiconductor chip 5 with a bonding wire 7 is performed. The bonding wires 7 may be, for example, gold wires, aluminum wires, or copper wires. The temperature when the wire bonding is performed is from 80 to 250° C., preferably from 80 to 220° C. The heating time is from several seconds to several minutes. The connection of the wires is performed by using a combination of vibration energy based on ultrasonic waves with compression energy based on the application of pressure in the state that the wires are heated to a temperature in the above-mentioned range.

Here, the die-bonding film 3a after thermosetting preferably has a shear adhering strength of 0.01 MPa or more at 175° C. and more preferably 0.01 to 5 MPa. When the shear adhering strength of the die-bonding film 3a after thermosetting is 0.01 MPa or more at 175° C., the generation of shear deformation at the adhesion surface of the die-bonding film 3 and the semiconductor chip 5 or the adherend 6 due to ultrasonic vibration and heating in a wire bonding step can be prevented. That is, moving of a semiconductor chip 5 due to ultrasonic vibration during wire bonding can be prevented, and thereby, the success rate of wire bonding is prevented from decreasing.

Moreover, the wire bonding step may be performed without thermosetting the die-bonding film 3a by a heat treatment. In this case, the die-bonding film 3a preferably has a shear adhering strength to the adherend 6 at 25° C. of 0.2 MPa or more, more preferably 0.2 to 10 MPa. When the shear adhering strength is 0.2 MPa or more, the generation of shear deformation at the adhesion surface of the die-bonding film 3a and the semiconductor chip 5 or the adherend 6 due to ultrasonic vibration and heating in the wire bonding step can be decreased even when the wire bonding step is performed without undergoing a heating step. That is, moving of a semiconductor element due to ultrasonic vibration during wire bonding can be prevented, and thereby, the success rate of wire bonding is prevented from decreasing.

Further, the uncured die-bonding film 3a does not completely thermoset even when the wire bonding step is performed. The shear adhering strength of the die-bonding film 3a is necessarily 0.2 MPa or more even when the temperature is within a range of 80 to 250° C. When the shear adhering strength is less than 0.2 MPa in this temperature range, the semiconductor chip 5 moves due to the ultrasonic vibration during wire bonding and the wire bonding cannot be performed, and therefore the yield decreases.

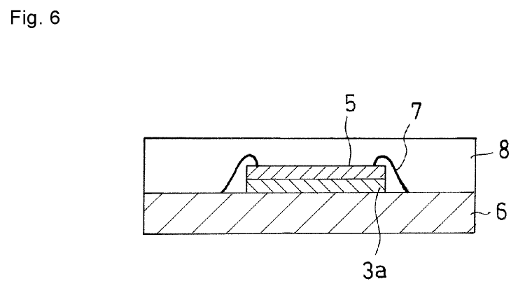

Then, a sealing step sealing the semiconductor chip 5 with a sealing resin 8 is performed (see FIG. 6). This step is performed for protecting the semiconductor chip 5 that is loaded on the adherend 6 and the bonding wire 7. This step is performed by molding a resin for sealing with a mold. An example of the sealing resin 8 is an epoxy resin. The heating temperature during the resin sealing is normally 175° C. and it is performed for 60 to 90 seconds. However, the present invention is not limited thereto, and the curing can be performed at 165 to 185° C. for a few minutes, for example. Accordingly, the sealing resin is cured, and the die-bonding film 3a is also thermally cured when it has not been thermally cured. That is, in the present invention, even in the case where a post-curing step described below is not performed, it is possible to thermally cure the die-bonding film 3a to adhere the semiconductor chip 5 in the present step, which contributes to a decrease in the number of manufacturing steps and to a reduction of production period of a semiconductor device.

In the post curing step, the sealing resin 8 that is insufficiently cured in the sealing step is completely cured. Even when the die-bonding film 3a is not thermally cured in the sealing step, thermosetting and adhering and fixing of the die-bonding film 3a together with the sealing resin 8 becomes possible in the present step. The heating temperature in this step differs depending on the type of the sealing resin. However, it is within a range of 165 to 185° C., for example, and the heating time is about 0.5 to 8 hours. Therefore, the semiconductor device according to the present embodiment can be manufactured.

Hereinafter, the preferred examples of the present invention are illustratively described in detail. However, the present invention is not limited to these examples.

### Example 1

An ultraviolet ray-curable acrylic pressure-sensitive adhesive solution was applied onto a supporting base material comprised of a polyethylene film having a thickness of 100 μm and dried to form a pressure-sensitive adhesive layer having a thickness of 20 μm. Thereafter, only a portion corresponding to the wafer pasting part in the pressure-sensitive adhesive layer was irradiated with ultraviolet rays in a dose of 500 mJ/cm² to give a dicing film comprised of the supporting base material and the pressure-sensitive adhesive layer wherein the wafer pasting part had been cured by ultraviolet rays. The conditions for ultraviolet ray irradiation will be described below.

A solution of the ultraviolet ray-curable acrylic pressure-sensitive adhesive was prepared as follows. That is, a composition comprised of 100 parts by weight of ethylhexyl acrylate and 16 parts by weight of 2-hydroxyethyl acrylate was first copolymerized in a toluene solution to obtain an acrylic polymer with a weight average molecular weight of 500000.

Next, 100 parts by weight of this acrylic polymer was subjected to an addition reaction with 20 parts by weight of 2-methacryloyloxyethyl isocyanate to introduce a carbon-carbon double bond into a side chain in the polymer molecule. Further, 2 parts by weight of a polyfunctional isocyanate-based crosslinking agent and 7 parts by weight of an acetophenone-based photopolymerization initiator were added based on 100 parts by weight of this polymer and a mixture thereof was then dissolved homogenously in toluene as an organic solvent. Accordingly, a solution of an acrylic pressure-sensitive adhesive having a concentration of 20% by weight was prepared.

Further, the die-bonding film was manufactured as follows. That is, 32 parts by weight of an epoxy resin (EPICOAT 1001, manufactured by JER Co., Ltd.), 34 parts by weight of a phenol resin (MILEX XLC-4L, manufactured by Mitsui Chemicals, Inc.), 100 parts by weight of an acrylic acid ester-based polymer, i.e., an acrylic copolymer having ethyl acrylate-methylmethacrylate as the main component (Teisan Resin SG-708-6, manufactured by Nagase ChemteX Corporation), 110 parts by weight of sphere silica having an average particle size of 500 nm (SO-25R, manufactured by Admatechs) were dissolved in methyl ethyl ketone, and the concentration thereof was adjusted to 23.6% by weight, thereby preparing an adhesive composition.

A solution of this adhesive composition was applied onto a release treated film (peeling liner) comprised of a polyethylene terephthalate film having a thickness of 100 μm which had been subjected to a silicone release treatment, and then dried at 120° C. for 3 minutes. Accordingly, a thermosetting die-bonding film having a thickness of 10 μm was manufactured. Furthermore, the dicing die-bonding film of the present example was obtained by transferring the die-bonding film onto the pressure-sensitive adhesive layer of the pressure-sensitive adhesive film comprised of the acrylic pressure-sensitive adhesive described above.

### Example 2

In this example, the dicing die-bonding film of the present example was manufactured in the same manner as in Example 1, except that the dicing film was manufactured using the solution of an acrylic pressure-sensitive adhesive of Example 1 to which was further added 50 parts by weight of dipentaerythritol monohydroxypentaacrylate as a photopolymerizable compound.

### Example 3

In this example, the dicing die-bonding film of the present example was manufactured in the same manner as in Example 1 described above, except that a solution of an acrylic pressure-sensitive adhesive prepared as shown below was used.

That is, a composition comprised of 50 parts by weight of ethyl acrylate, 50 parts by weight of butyl acrylate and 16 parts by weight of 2-hydroxyethyl acrylate to be incorporated was first copolymerized in toluene to obtain an acrylic polymer with a weight average molecular weight of 500000.

Next, 100 parts by weight of this acrylic polymer was subjected to an addition reaction with 20 parts by weight of 2-methacryloyloxyethyl isocyanate to introduce a carbon-carbon double bond into the inside chain of the polymer molecule. Further, 1 part by weight of a polyfunctional isocyanate-based crosslinking agent and 3 parts by weight of an acetophenone-based photopolymerization initiator were incorporated based on 100 parts by weight of this polymer and then dissolved homogenously in toluene as an organic solvent. Accordingly, a solution of an acrylic pressure-sensitive adhesive having a concentration of 20% by weight was prepared. Further, 25 parts by weight of dipentaerythritol monohydroxypentaacrylate as a photopolymerizable compound was added to the solution of an acrylic pressure-sensitive adhesive to obtain the solution of an acrylic pressure-sensitive adhesive of the present example.

### Example 4

In this example, the dicing die-bonding film of the present example was manufactured in the same manner as in Example 3 described above, except that the compounding amount of dipentaerythritol monohydroxypentaacrylate as a photopolymerizable compound was changed to 100 parts by weight.

### Example 5

In this example, the dicing die-bonding film of the present example was manufactured in the same manner as in Example 1 described above, except that the compounding amount of the polyfunctional isocyanate-based crosslinking agent was changed to 1 part by weight.

### Comparative Example 1

In this comparative example, the dicing die-bonding film of the present comparative example was manufactured in the same manner as in Example 3 described above, except that the compounding amount of the polyfunctional isocyanate-based crosslinking agent was changed to 8 parts by weight, and the amount of the acetophenone-based photopolymerization initiator was changed to 7 parts by weight.

### Comparative Example 2

In this comparative example, the dicing die-bonding film of the present comparative example was manufactured in the same manner as in Example 4 described above, except that the die-bonding film manufactured by the following method was used.

That is, 32 parts by weight of an epoxy resin (EPICOAT 1001, manufactured by JER Co., Ltd.), 34 parts by weight of a phenol resin (MILEX XLC-4L, manufactured by Mitsui Chemicals, Inc.), 100 parts by weight of an acrylic acid ester-based polymer, i.e., an acrylic copolymer having ethyl acrylate-methyl methacrylate as the main component (Teisan Resin SG-708-6, manufactured by Nagase ChemteX Corporation), 9 parts by weight of sphere silica having an average particle size of 500 nm (SO-25R, manufactured by Admatechs) were dissolved in methyl ethyl ketone, and adjusted so that the concentration thereof was 23.6% by weight, thereby to give an adhesive composition.

A solution of this adhesive composition was applied onto a film treated with a release agent (peeling liner) comprised of a polyethylene terephthalate film having a thickness of 100 μm which had been treated with a silicone release agent, and then dried at 120° C. for 3 minutes. Accordingly, a thermosetting die-bonding film having a thickness of 10 μm was manufactured.

### Comparative Example 3

In this comparative example, the dicing die-bonding film of the present comparative example 3 was manufactured in the same manner as in Example 4 described above, except that the die-bonding film which had been manufactured by the following method was used.

That is, 8 parts by weight of an epoxy resin (EPICOAT 1001, manufactured by JER Co., Ltd.), 9 parts by weight of a phenol resin (MILEX XLC-4L, manufactured by Mitsui Chemicals, Inc.), 100 parts by weight of an acrylic acid ester-based polymer, i.e., an acrylic copolymer having ethyl acrylate-methylmethacrylate as the main component (Teisan Resin SG-708-6, manufactured by Nagase ChemteX Corporation), 73 parts by weight of sphere silica having an average particle size of 500 nm (SO-25R, manufactured by Admatechs) were dissolved in methyl ethyl ketone, and adjusted so that the concentration thereof was 23.6% by weight, thereby to give an adhesive composition.

A solution of this adhesive composition was applied onto a film treated with a release agent (peeling liner) comprised of a polyethylene terephthalate film having a thickness of 100 μm which had been treated with a silicone release agent, and then dried at 120° C. for 3 minutes. Accordingly, a thermosetting die-bonding film having a thickness of 10 μm was manufactured.

### (Measurement of Thickness of Pressure-Sensitive Adhesive Layer)

The thickness of the pressure-sensitive adhesive layer formed in each of examples and comparative examples was measured at 20 points using a 1/1000 dial gauge, and the average of these measured values was served as the thickness.

### (Measurement of Storage Elastic Modulus of Dicing Film)

A strip of 30 mm in length (measurement length), 10 mm in width, and 0.5 mm in thickness was cut out with a utility knife from the dicing film manufactured in each of examples and comparative examples, the storage elastic modulus at −50 to 200° C. of which was measured using a viscoelasticity spectrometer (Trade name: RSAII, manufactured by Rheometric Scientific, Inc.). The measurement conditions were as follows: a frequency of 1 Hz and a temperature rising speed of 10° C./min. The values of the storage elastic modulus at 23° C. are shown in Table 1 below.

### (Measurement of Storage Elastic Modulus of Die-Bonding Film)

A strip of 30 mm in length (measurement length), 20 mm in width, and 0.5 mm in thickness was cut out with a utility knife from the die-bonding films manufactured in each of examples and comparative examples, the storage elastic modulus at −50 to 200° C. of which was measured using a viscoelasticity spectrometer (Trade name: RSAII, manufactured by Rheometric Scientific, Inc.). The measurement conditions were as follows: a frequency of 1 Hz and a temperature rising speed of 10° C./min. The values of the storage elastic modulus at 23° C. are shown in Table 1 below.

(Peeling Force after Dicing)

The dicing die-bonding film obtained in each of examples and comparative examples was mounted onto a semiconductor wafer at 60±3° C. A semiconductor wafer with 8 inches in size of which backside had been ground to 75 μm in thickness was used. The grinding conditions and attaching conditions are as follows.

### <Wafer Grinding Conditions>

Grinding apparatus: DFG-8560, manufactured by DISCO Corporation
Semiconductor wafer: 8 inch diameter (backside was ground so as to modify a thickness from 0.75 mm to 75 μm)

### <Attaching Conditions>

Attaching apparatus: MA-3000II, manufactured by Nitto Seiki Co., Ltd.
Attaching speed: 10 mm/min
Attaching pressure: 0.15 MPa
Stage temperature when attaching: 60±3° C.

Next, the semiconductor wafer was diced to form semiconductor chips. The dicing was carried out so that the chips had each a size of 10 mm square. The dicing conditions are as follows.

### <Dicing Conditions>

Dicing apparatus: DFD-651, manufactured by DISCO Corporation
Dicing blade: 27HEDD, manufactured by DISCO Corporation
Dicing ring: 2-8-1 (manufactured by DISCO Corporation)
Dicing speed: 30 mm/sec
Dicing depth: 85 μm (distance from a chuck table)
Dicing blade rotation number: 40,000 rpm
Cutting mode: down-cut mode
Wafer chip size: 10.0 mm square

After dicing, an arbitrary row in which five or more semiconductor chips were continuously formed was cut out together with the dicing die-bonding film. The cutting was performed such that the dicing die-bonding film at the time of cutting out was allowed to have a tape width of 10 mm. In addition, void formation between the dicing film and the die-bonding film was not allowed to occur. Then, semiconductor chips in line were fixed to an SUS board through a double-sided pressure-sensitive adhesive tape interposed therebetween.

Thereafter, the die-bonding film was peeled off from the dicing film with a peeling angle of 180°, and the maximum peak value of a peeling force F1 (N/10 mm) was measured in the region of 1 mm from the cut surface. The results are shown in Table 1 below.

### (Peeling Force)

The dicing die-bonding film obtained in each of examples and comparative examples was cut into a strip having a tape width of 20 mm. Then, a peeling force F2 (N/10 mm) was measured when the dicing film was peeled off from the die-bonding film under the conditions of a temperature of 23±3° C. (room temperature), a peeling angle of 180°, and a peeling point moving rate of 300 mm/min. The results are shown in Table 1 below.

### (Pickup)

Using the dicing die-bonding film of each of examples and comparative examples, pickup was performed after actually dicing a semiconductor wafer in a manner described below, and performances of each dicing die-bonding film were evaluated.

That is, the dicing die-bonding film obtained in each of examples and comparative examples was mounted onto a semiconductor wafer at 60±3° C. The semiconductor wafer with 8 inches in size of which backside had been ground to 75 μm in thickness was used. Next, the semiconductor wafer was diced to form 50 semiconductor chips. The dicing was performed by cutting to a dicing depth of 85 μm so that a chip size of 10 mm square was obtained. The wafer grinding conditions for backside grinding, attaching conditions for mounting a semiconductor wafer, and dicing conditions for a semiconductor wafer were the same as the above mentioned conditions.

Next, an expansion step was conducted by stretching each dicing die-bonding film to allow a space between chips to be a predetermined interval. The expanding conditions are as follows. Evaluation of pickup properties was conducted by picking up the semiconductor chip by a method of pushing-up the semiconductor chip with a needle from the base material side of each dicing die-bonding film. Specifically, 10 semiconductor chips were continuously picked up under the following conditions, and the number of semiconductor chips that were not able to be picked up was counted to calculate the success rate. The results are shown in Table 1 below.

### <Expanding Conditions>

Diebonder: manufactured by SHINKAWA Ltd., Device name: SPA-300
Pull-down amount of outer ring to inner ring: 3 mm

### <Pickup Conditions>

Die bonding device: manufactured by SHINKAWA Ltd., Device name: SPA-300
Number of needles: 9
Pushing up amount of needle: 0.50 mm
Pushing up speed of needle: 5 mm/sec
Adsorption retention time: 1 second

### (Results)

As apparent from Table 1 below, it was confirmed that the pickup properties were good when the peeling force F1 between the dicing film and the die-bonding film in the vicinity of the cut surface after dicing was within a range of 0.7 N/10 mm or less as in Examples 1 to 5, while the pickup properties were deteriorated when the peeling force F1 exceeded 0.7 N/10 mm as in Comparative Examples 1 to 3.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Storage elastic modulus E′ | 20 | 123 | 254 | 481 | 5 | 802 | 481 | 481 |
| of dicing film (MPa) | | | | | | | | |
| Peeling force F1 (N/10 mm) | 0.1 or less | 0.1 or less | 0.4 | 0.6 | 0.1 or less | 0.8 | 1.0 or more | 1.0 or more |
| Peeling force F2 (N/20 mm) | 0.08 | 0.05 | 0.03 | 0.02 | 0.16 | 0.05 | 0.10 | 0.20 |
| Storage elastic modulus E′ | 16 | 16 | 16 | 16 | 16 | 16 | 8 | 2 |
| of die-bonding film (MPa) | | | | | | | | |
| B/(A + B) (−) | 0.4 | 0.4 | 0.4 | 0.4 | 0.4 | 0.4 | 0.05 | 0.4 |
| Pickup success rate (%) | 100 | 100 | 100 | 80 | 90 | 20 | 0 | 0 |

In the table, A (parts by weight) represents the total weight of an epoxy resin, a phenol resin, and an acrylic copolymer, and B (parts by weight) represents the weight of a filler. In addition, the peeling force F1(N/10 mm) represents the maximum peeling force in the vicinity of the cut surface when a dicing film was peeled off from a die-bonding film after dicing, and the peeling force F2(N/20 mm) represents a peeling force in other than the vicinity of the cut surface.

1. A dicing die-bonding film, comprising
a dicing film having at least a pressure-sensitive adhesive layer formed on a supporting base material, and
a die-bonding film formed on the pressure-sensitive adhesive layer, wherein
the thickness of the pressure-sensitive adhesive layer is 5 to 80 μm, and
when the dicing film is peeled off from the die-bonding film after dicing from the side of the die-bonding film to a part of the pressure-sensitive adhesive layer, the maximum value of a peeling force in the vicinity of the cut surface is 0.7 N/10 mm or less under the conditions of a temperature of 23° C., a peeling angle of 180°, and a peeling point moving rate of 10 mm/min.

2. The dicing die-bonding film according to claim 1, wherein the storage elastic modulus of the pressure-sensitive adhesive layer at 23° C. is 1×10⁷ Pa to 5×10⁸ Pa.

3. The dicing die-bonding film according to claim 1, wherein the peeling force when the dicing film is peeled off from the die-bonding film is within a range of 0.01 N/20 mm to 0.15 N/20 mm under the conditions of a temperature of 23° C., a peeling angle of 180°, and a peeling point moving rate of 300 mm/min before dicing.

4. The dicing die-bonding film according to claim 1, wherein the pressure-sensitive adhesive layer is formed by a radiation-curing type pressure-sensitive adhesive, and a photopolymerizable compound in a range of more than 0 parts by weight to 50 parts by weight or less based on 100 parts by weight of a base polymer is added to the radiation-curing type pressure-sensitive adhesive.

5. The dicing die-bonding film according to claim 1, wherein the pressure-sensitive adhesive layer is formed by a radiation-curing type pressure-sensitive adhesive, and a photopolymerization initiator in a range of 1 part by weight or more to 8 parts by weight or less based on 100 parts by weight of a base polymer is added to the radiation-curing pressure-sensitive adhesive.

6. The dicing die-bonding film according to claim 1, wherein
the die-bonding film is formed by at least an epoxy resin, a phenol resin, an acrylic copolymer and a filler,
B/(A+B) is 0.1 or more when the total weight of the epoxy resin, the phenol resin, and the acrylic copolymer is defined as A parts by weight and the weight of the filler is defined as B parts by weight, and
the storage elastic modulus of the die-bonding film at 23° C. before thermal curing is 5 MPa or more.

7. The dicing die-bonding film according to claim 6, wherein the peeling force when the dicing film is peeled off from the die-bonding film is within a range of 0.01 N/20 mm to 0.15 N/20 mm under the conditions of a temperature of 23° C., a peeling angle of 180°, and a peeling point moving rate of 300 mm/min before dicing.

8. The dicing die-bonding film according to claim 6, wherein the pressure-sensitive adhesive layer is formed by a radiation-curing type pressure-sensitive adhesive, and a photopolymerizable compound in a range of more than 0 parts by weight to 50 parts by weight or less based on 100 parts by weight of a base polymer is added to the radiation-curing type pressure-sensitive adhesive.

9. The dicing die-bonding film according to claim 6, wherein the pressure-sensitive adhesive layer is formed by a radiation-curing type pressure-sensitive adhesive, and a photopolymerization initiator in a range of 1 part by weight or more to 8 parts by weight or less based on 100 parts by weight of a base polymer is added to the radiation-curing pressure-sensitive adhesive.

10. The dicing die-bonding film according to claim 1, wherein when the dicing film is peeled off from the die-bonding film after dicing from the side of the die-bonding film to a part of the pressure-sensitive adhesive layer, the maximum value of a peeling force within 1 mm from the cut surface toward the inside of a semiconductor chip is 0.7 N/10 mm or less under the conditions of a temperature of 23° C., a peeling angle of 180°, and a peeling point moving rate of 10 mm/min.

11. The dicing die-bonding film according to claim 1, wherein the thickness of the pressure-sensitive adhesive layer 2 is 5 to 80 μm.
